(19) United States
(12) Patent Application Publication
(10) Pub. No.: US 2017/0369700 A1
(43) Pub. Date: Dec. 28, 2017

(54) EPOXY RESIN COMPOSITION, AND FILM, PREPREG, AND FIBER-REINFORCED PLASTIC USING SAME

(71) Applicant: Mitsubishi Rayon Co., Ltd., Chiyoda-ku (JP)

(72) Inventors: Hirokazu MITOBE, Tokyo (JP); Kenichi WATANABE, Tokyo (JP); Tomoko ISHIMOTO, Tokyo (JP); Shinya KATOU, Tokyo (JP)

(73) Assignee: Mitsubishi Chemical Corporation, Chiyoda-ku (JP)

(21) Appl. No.: 15/537,668

(22) PCT Filed: Dec. 17, 2015
(86) PCT No.: PCT/JP2015/085336

§ 371 Date: Jun. 19, 2017

(30) Foreign Application Priority Data
Dec. 25, 2014 (JP) 2014-261453

(51) Int. Cl. C08L 63/00; C08J 5/18; C08J 5/04; C08G 59/32; C08J 5/24; C08G 59/40

(52) U.S. Cl. CPC C08L 63/00; C08J 5/24; C08G 59/4021; C08J 5/042; C08G 59/32; C08J 5/18; C08J 2363/00; C08J 2463/00; C08L 2205/025

(57) ABSTRACT

An epoxy resin composition suitable for molding a fiber-reinforced plastic molded article is provided. The molded article has exceptional mechanical properties. In particular, a tubular molded article has high breaking strength. The epoxy resin composition contains components (A), (C), and (D), where component (A) is an epoxy resin of a particular formula, component (C) is an epoxy resin other than component (A) that is liquid at 25° C., and component (D) is a curing agent.

### TECHNICAL FIELD

The present invention relates to an epoxy resin composition preferably used in fiber-reinforced plastics for sports and leisure applications, industrial applications and the like and also relates to a film, a prepreg, and a fiber-reinforced plastic using the epoxy resin composition.

The invention claims priority right based on Japanese Patent Applications No. 2014-261453 filed in Japan on Dec. 25, 2014, and the contents thereof are incorporated herein by reference.

### BACKGROUND ART

Fiber-reinforced plastics, which are one of the fiber-reinforced composite materials, have light weight, high strength, and high rigidity, and thus are widely used in products ranging from sports and leisure applications to industrial applications such as automobiles and aircrafts.

As a method for producing fiber-reinforced plastics, there is a method of using an intermediate material, that is, a prepreg, formed by impregnating a matrix resin in a reinforcing material composed of long fiber (continuous fiber) such as reinforcing fiber. Such a method is advantageous in that the content of reinforcing fiber in fiber-reinforced plastics can be easily controlled and it is designed to have a large amount of reinforcing fiber.

Specific examples of a method for producing a fiber-reinforced plastic from a prepreg include a method using an autoclave, compression molding, internal-pressurizing molding, oven molding, and sheet wrap molding.

Among fiber-reinforced plastics, fiber-reinforced plastic tubular bodies are widely used in sports and leisure applications such as fishing rods, golf club shafts, ski poles, or bicycle frames. With utilization of high elastic modulus of fiber-reinforced plastics, it is possible to throw a ball or a fishing hook in a long distance with small force due to whip and reaction which occur at the time of swinging a tubular body. Furthermore, as light weight can be achieved by having a tubular body, operational feeling of a user can be improved.

In recent years, due to an increasing need for having light weight, it is attempted to change part of carbon fibers to carbon fibers with higher elastic modulus, for example.

However, when carbon fibers are prepared to have high elastic modulus, the carbon fibers tend to have lower strength and a fiber-reinforced plastic is easily broken in general. As such, there is a limitation in use amount of carbon fibers with high elastic modulus. Furthermore, being highly expensive, the carbon fibers with high elastic modulus are disadvantageous from the economic point of view. Meanwhile, regarding a fiber-reinforced plastic in which conventional carbon fibers are used as they are, if the use amount of a prepreg is lowered to reduce the weight, the fracture strength of a tubular body is deteriorated.

Under the circumstances, the fracture strength of a fiber-reinforced plastic tubular body needs to be improved by a method other than the method based on modification of elastic modulus of carbon fibers.

To solve the problems described above, use of an epoxy resin composition is suggested in Patent Literature 1 and Patent Literature 2, for example.

### CITATION LIST

### Patent Literature

Patent Literature 1: JP 2002-284852 A

Patent Literature 2: JP 11-171972 A

### SUMMARY OF THE INVENTION

### Problem to be Solved by the Invention

However, the epoxy resin composition described in Patent Literature 1 and Patent Literature 2 is not sufficient in terms of 90° bending strength of a fiber-reinforced plastic.

The invention is devised under the circumstances described above, and it is found that, by using a specific epoxy resin composition as a matrix resin, a fiber-reinforced plastic with excellent mechanical properties can be provided. In particular, the invention is to provide an epoxy resin composition which can provide excellent fracture strength when the composition is used as a material for fiber-reinforced plastic tubular body, a prepreg using the resin composition, and a fiber-reinforced plastic formed by using the prepreg.

### Means for Solving Problem

As a result of carrying out intensive studies, the present inventors found that, by using an epoxy resin with specific structure, the aforementioned problems can be solved and a fiber-reinforced plastic with desired performance can be provided, and thus the invention is completed accordingly.

Namely, the gist of the invention is as described below.

[1] An epoxy resin composition containing the following components (A), (C), and (D):

component (A): an epoxy resin represented by the following Chemical Formula (1),

component (C): an epoxy resin other than the component (A) which is in liquid phase at 25° C., and

component (D): a curing agent.

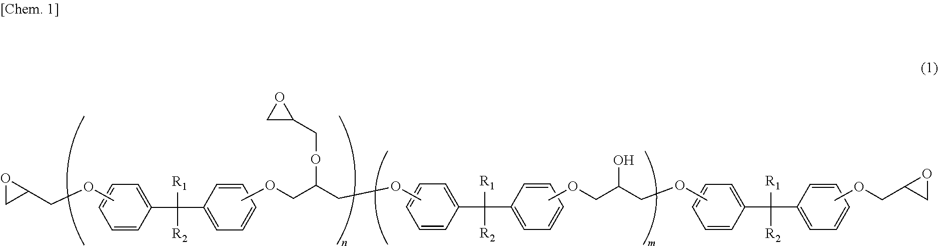

in the formula (1), n and m represent a mean value, n is a real number within a range of from 1 to 10, m is a real number within a range of from 0 to 10, and R₁ and R₂ each independently represent a hydrogen atom or any one of an alkyl group having 1 to 4 carbon atoms and a trifluoromethyl group.

[2] The epoxy resin composition described in above [1], further containing the following component (B):

component (B): an epoxy resin other than the component (A) which is solid at 25° C.

[3] The epoxy resin composition described in above [1] or [2], in which content of the component (A) is 1 part by mass or more and 80 parts by mass or less relative to 100 parts by mass of the total amount of the epoxy resin contained in the epoxy resin composition.

[4] The epoxy resin composition described in above [2] or [3], in which the component (B) is a solid epoxy resin having softening point or melting point of 50° C. or higher.

[5] The epoxy resin composition described in any one of above [2] to [4], in which the component (B) is at least one epoxy resin selected from a group consisting of bisphenol A type epoxy resin, bisphenol F type epoxy resin, bisphenol S type epoxy resin, oxazolidone ring type epoxy resin, and alicyclic epoxy resin.

[6] The epoxy resin composition described in any one of above [2] to [5], in which the alicyclic epoxy resin represented by the following Chemical Formula (2) is contained as the component (B).

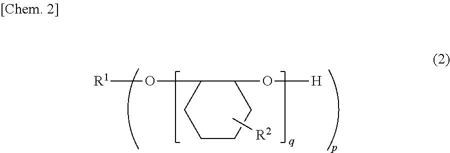

[in Formula (2), R¹ represents an organic group with valency of p. p represents an integer of 1 to 20. q represents an integer of 1 to 50, and the total of q in Formula (2) is an integer of 3 to 100. R² represents any one group represented by the following Formula (2a) or (2b), with the proviso that at least one R² in Formula (2) is a group represented by Formula (2a).

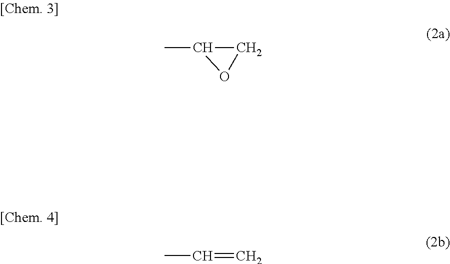

[7] The epoxy resin composition described in above [6], in which 1,2-epoxy-4-(2-oxyranyl)cyclohexane adduct of 2,2-bis(hydroxymethyl)-1-butanol is contained as the alicyclic epoxy resin.

[8] The epoxy resin composition described in any one of above [2] to [7], in which content of the component (B) is 5 parts by mass or more and 60 parts by mass or less relative to 100 parts by mass of the total amount of the epoxy resin contained in the epoxy resin composition.

[9] The epoxy resin composition described in any one of above [1] to [8], in which the component (C) is a bi- or higher functional epoxy resin.

[10] The epoxy resin composition described in above [9], in which the component (C) is a bisphenol type epoxy resin.

[11] The epoxy resin composition described in any one of above [1] to [10], in which content of the component (C) is 20 parts by mass or more and 99 parts by mass or less relative to 100 parts by mass of the total amount of the epoxy resin contained in the epoxy resin composition.

[12] The epoxy resin composition described in any one of above [1] to [11], in which the component (D) is dicyandiamide.

[13] The epoxy resin composition described in any one of above [1] to [12], further containing a urea-based curing aid as the component (E).

[14] The epoxy resin composition described in any one of above [1] to [13], in which a thermoplastic resin is contained at 0.1 to 10 parts by mass relative to 100 parts by mass of the total amount of the epoxy resin contained in the epoxy resin composition.

[15] The epoxy resin composition described in above [14], in which the thermoplastic resin is at least one selected from a phenoxy resin, a polyvinyl acetal resin, a triblock copolymer of poly(methyl methacrylate)/poly(butyl acrylate)/poly(methyl methacrylate), and a triblock copolymer of poly(styrene)/poly(butadiene)/poly(methacrylic acid methyl).

[16] A film composed of the epoxy resin composition described in any one of above [1] to [15].

[17] A prepreg having the epoxy resin composition described in any one of above [1] to [15] impregnated in a reinforcing fiber substrate.

[18] A fiber-reinforced plastic composed of a cured product of the epoxy resin composition described in any one of [1] to [15] and a reinforcing fiber.

[19] The fiber-reinforced plastic described in [18], having a tubular shape.

[20] An epoxy resin composition which contains an epoxy resin and a curing agent, and satisfies the following (1) to (4):

(1) bending elastic modulus of a cured product of the epoxy resin composition is 3.3 GPa or higher,

(2) bending strain at break of a cured product of the epoxy resin composition is 9% or higher,

(3) 90° bending strength of a fiber-reinforced plastic composed of a cured product of the epoxy resin composition and a reinforcing fiber substrate, in which carbon fibers as continuous fibers are arranged evenly in one direction, is 150 MPa or higher, and

(4) 90° bending strain at break of the fiber-reinforced plastic described in above (3) is 1.8% or higher.

### Effect of the Invention

By using the epoxy resin composition of the invention as a matrix resin of a fiber-reinforced plastic, a fiber-reinforced plastic with excellent mechanical properties is obtained. In particular, by using the epoxy resin composition of the invention, excellent fracture strength can be obtained from a fiber-reinforced plastic tubular body.

### MODE(S) FOR CARRYING OUT THE INVENTION

The invention is achieved by an epoxy resin composition containing the following components (A), (C), and (D), and a use thereof

component (A): an epoxy resin represented by the following Chemical Formula (1),

component (C): an epoxy resin other than the component (A) which is in liquid phase at 25° C., and

component (D): a curing agent.

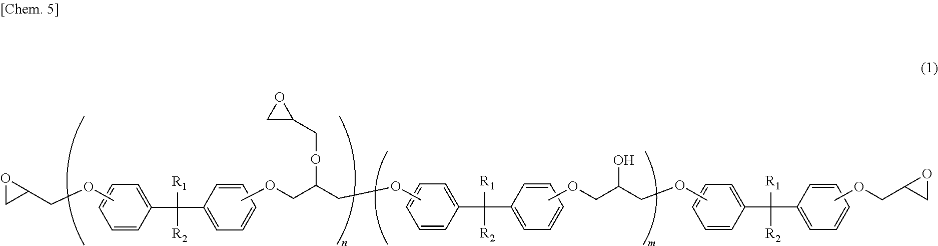

in Formula, n and m represent a mean value, n is a real number within a range of from 1 to 10, m is a real number within a range of from 0 to 10, and R₁ and R₂ each independently represent a hydrogen atom or any one of an alkyl group having 1 to 4 carbon atoms and a trifluoromethyl group.

Incidentally, the term “epoxy resin” is generally used as a name of one category of thermocurable resins, or a name of a category of chemical substances as a compound having an epoxy group in the molecule. In the invention, it is used with the latter meaning (with the proviso that, the mass average molecular weight of the epoxy resin is less than 50000). Furthermore, the term “epoxy resin composition” means a composition which contains an epoxy resin, a curing agent, and depending on a case, other additives.

In the invention, the “bending elastic modulus of a cured product of the epoxy resin composition” may be referred to as “resin bending elastic modulus”, the “bending strain at break of a cured product of the epoxy resin composition” may be referred to as “resin bending strain at break”, and the “90° bending strength of a fiber-reinforced plastic composed of a cured product of the epoxy resin composition and a reinforcing fiber substrate, in which carbon fibers as continuous fibers are arranged evenly in one direction” may be simply referred to as “90° bending strength of a fiber-reinforced plastic”.

Hereinbelow, each component is described in detail.

“Component (A): Epoxy Resin Represented by the Following Chemical Formula (1)”

The epoxy resin composition of the invention contains, as the component (A), the epoxy resin represented by the following Formula (1).

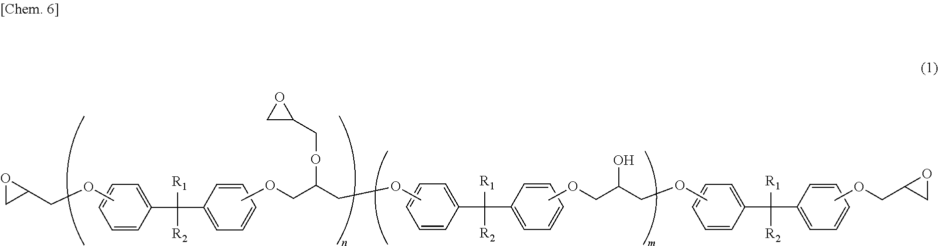

In the formula (1), n and m represent a mean value, n is a real number within a range of from 1 to 10, m is a real number within a range of from 0 to 10, and R₁ and R₂ each independently represent a hydrogen atom or any one of an alkyl group having 1 to 4 carbon atoms and a trifluoromethyl group.

The epoxy resin represented by the above Chemical Formula (1) can increase the bending strength of a cured product of the epoxy resin composition, and when the epoxy resin is used for a matrix resin of a fiber-reinforced plastic, it can increase the 90° bending strength of a fiber-reinforced plastic.

Examples of the epoxy resin represented by the above Chemical Formula (1) include NER-7604, NER-7403, NER-1302, and NER-1202 (all manufactured by Nippon Kayaku Co., Ltd.: epoxy equivalents of 200 g/eq. or more and 500 g/eq. or less, and softening point of 55° C. or higher and 75° C. or lower).

The component (A) may be used either singly or 2 or more types thereof may be suitably selected and used. However, from the viewpoint of enhancing the resin bending elastic modulus, it is preferably an epoxy resin which is represented by the following Chemical Formula (1a) (for example, NER-7604 and NER-7403), and from the viewpoint of enhancing the resin bending strain at break, those in which total of k and j is 5 or more are preferable, and NER-7604 is particularly preferable.

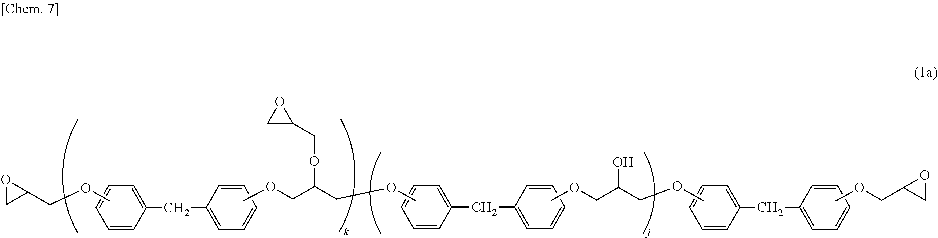

In the formula (1), k and j represent a mean value, and k represents a real number within a range of 1 to 10 and j represents a real number within a range of 0 to 10.

It is preferable that the component (A) is 1 part by mass or more and 80 parts by mass or less relative to 100 parts by mass of the total amount of the epoxy resin contained in the epoxy resin composition. That is because, as the amount of the component (A) is 1 part by mass or more, the bending strength of a cured product of the epoxy resin composition of the invention can be increased, and also the 90° bending strength of a fiber-reinforced plastic can be increased when the composition is used for a matrix resin of a fiber-reinforced plastic. The amount is more preferably 5 parts by mass or more, and even more preferably 10 parts by mass or more. Furthermore, as the amount of the component (A) is 80 parts by mass or less, there is a tendency that the impregnation property of the resin is improved during the process for producing a prepreg, the handlability of a prepreg to be obtained (adhesive property, drape property, and winding property on mandrel) is improved, and the physical properties of fiber-reinforced composite materials are improved. The amount is more preferably 70 parts by mass or less, and even more preferably 60 parts by mass or less.

“Component (B): Epoxy Resin Other than the Component (A) Which is Solid at 25° C.”

The epoxy resin composition of the invention may contain, as the component (B), an epoxy resin which is solid at 25° C., if necessary.

With the epoxy resin which is solid at 25° C., the bending elastic modulus and heat resistance of a cured product of the epoxy resin composition can be further enhanced, and also the adhesiveness of the matrix resin to reinforcing fibers can be increased when the composition is used for a matrix resin of a fiber-reinforced plastic.

The epoxy resin which is solid at 25° C. is at least one selected from a group consisting of bisphenol A type epoxy resin, bisphenol F type epoxy resin, bisphenol type epoxy resin, oxazolidone ring type epoxy resin, and alicyclic epoxy resin. The component (B) may be used either singly or two or more types thereof may be suitably selected and used. Still, it is preferable to use a resin which has softening point or boiling point of 50° C. or higher.

That is because, as the component (B) which has softening point or boiling point of 50° C. or higher is used, there is a tendency that suitable adhesiveness for a prepreg is obtained and favorable handlability is obtained. The softening point or boiling point is preferably 60° C. or higher, and more preferably 70° C. or higher. Furthermore, the softening point or boiling point of the component (B) is preferably 160° C. or lower from the viewpoint of having favorable compatibility with other components. More preferably, the softening point or boiling point is 150° C. or lower.

Examples of the bisphenol A type epoxy resin which may be used as the component (B) include jER1001 (softening point: 64° C.) jER1003 (softening point: 89° C.), jER1004 (softening point: 97° C.), jER1007 (softening point: 128° C.), and jER1009 (softening point: 144° C.) (all manufactured by Mitsubishi Chemical Corporation), and Epotohto YD-014 (softening point: 91° C. or higher and 102° C. or lower), Epotohto YD-017 (softening point: 117° C. or higher and 127° C. or lower), and Epotohto YD-019 (softening point: 130° C. or higher and 145° C. or lower) (all manufactured by THOTO Chemical Industry Co., Ltd.). Furthermore, examples of the bisphenol F type epoxy resin which may be used as the component (B) include jER4004P (softening point: 85° C.) jER4007P (softening point: 108° C.) and jER4010P (softening point: 135° C.) (all manufactured by Mitsubishi Chemical Corporation).

Furthermore, examples of the bisphenol S type epoxy resin which may be used as the component (B) include EXA-1514 (softening point: 75° C.) and EXA-1517 (softening point: 60° C.) (all manufactured by DIC CORPORATION).

Furthermore, examples of the oxazolidone ring type epoxy resin which may be used as the component (B) include AER4152 (softening point: 98° C.) and XAC4151 (softening point: 98° C.) (all manufactured by ASAHI KASEI E-materials Corp.), ACR1348 (manufactured by ADEKA Corporation), and DER858 (manufactured by Dow Chemical Company, softening point: 100° C.).

Furthermore, examples of alicyclic epoxy resin which may be used as the component (B) include an alicyclic epoxy resin which is represented by the following Chemical Formula (2), and 1,2-epoxy-4-(2-oxyranyl)cyclohexane adduct of 2,2-bis(hydroxymethyl)-1-butanol, EHPE3150 (manufactured by Daicel Corporation, softening point: 75° C.) can be mentioned, for example.

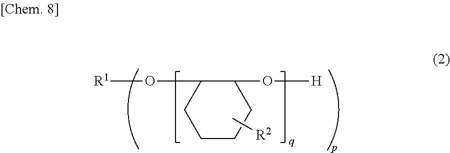

In Formula (2), R¹ represents an organic group with valency of p. p represents an integer of 1 to 20. q represents an integer of 1 to 50, and the total of q in Formula (2) is an integer of 3 to 100. R² represents any one group represented by the following Formula (2a) or (2b), with the proviso that at least one R² in Formula (2) is a group represented by Formula (2a).

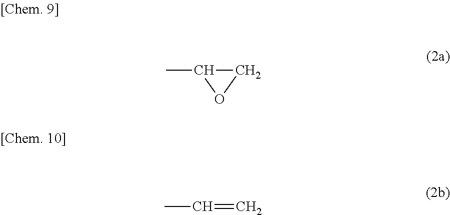

Examples of other epoxy resin which may be used as the component (B) include hydroquinone diglycidyl ether (for example, EX-203 (melting point of 88° C.)), diglycidyl terephthalate (for example, EX-711 (melting point of 106° C.)), and N-glycidyl phthalimide (for example, EX-731 (melting point of 95° C.)) (all manufactured by Nagase ChemteX Corporation).

As for the epoxy resin which is used as the component (B), at least one can be suitably selected from a group consisting of bisphenol A type epoxy resin, bisphenol F type epoxy resin, bisphenol S type epoxy resin, oxazolidone ring type epoxy resin, and alicyclic epoxy resin as described above. However, when an oxazolidone ring type epoxy resin is used, there is a tendency that the adhesiveness of the matrix resin to reinforcing fibers is increased, in particular. When an alicyclic epoxy resin or bisphenol S type epoxy resin is used, there is a tendency that the bending elastic modulus of the resin and the heat resistance of the resin are improved, in particular.

In the case of using the component (B), it is preferable that the content thereof is 5 parts by mass or more and 60 parts by mass or less relative to 100 parts by mass of the total amount of the whole epoxy resin contained in the epoxy resin composition. It is more preferably 7 parts by mass or more and 55 parts by mass or less, and even more preferably 9 parts by mass or more and 40 parts by mass or less.

That is because, there is a tendency that, when the amount of the component (B) is 5 parts by mass or more, the bending elastic modulus and heat resistance of the epoxy resin composition of the invention can be further increased, and also the adhesiveness of a matrix resin to reinforcing fibers can be increased when it is used for a matrix of a fiber-reinforced plastic. Furthermore, as the amount of the component (B) is 60 parts by mass or less, there is a tendency that the impregnation property of the resin is improved during the process for producing a prepreg, the handlability of a prepreg to be obtained (adhesive property, drape property, and winding property on mandrel) is improved, and the physical properties of fiber-reinforced composite materials are also improved.

In the epoxy resin composition of the invention, an epoxy resin other than the component (A) which is in liquid phase at 25° C. is contained as the component (C).

With the component (C), it is possible that the viscosity of the epoxy resin composition of the invention can be controlled within a suitable range and the viscous property of a prepreg containing the epoxy resin composition is regulated. Furthermore, by using the component (C), a molded article with fewer voids can be obtained when a fiber-reinforced plastic is produced from the prepreg.

As for the component (C), examples of the bisphenol A type epoxy resin include jER825 (viscosity at 25° C.: 40 poise or more and 70 poise or less), jER827 (viscosity at 25° C.: 90 poise or more and 110 poise or less), and jER828 (viscosity at 25° C.: 120 poise or more and 150 poise or less) (all manufactured by Mitsubishi Chemical Corporation), examples of the bisphenol F type epoxy resin include EPICLON 830 (manufactured by DIC CORPORATION, viscosity at 25° C.: 30 poise or more and 40 poise or less), jER806 (viscosity at 25° C.: 15 poise or more and 25 poise or less), and jER807 (viscosity at 25° C.: 30 poise or more and 45 poise or less) (all manufactured by Mitsubishi Chemical Corporation), examples of the hydrogenated bisphenol A type epoxy resin include TETRAD-C (manufactured by MITSUBISHI GAS CHEMICAL COMPANY, INC., viscosity at 25° C.: 20 poise or more and 35 poise or less), DENACOL EX-252 (manufactured by Nagase ChemteX Corporation, viscosity at 25° C.: 22 poise), DENACOL EX-201 as resorcin diglycidyl ether (manufactured by Nagase ChemteX Corporation, viscosity at 25° C.: 2.5 poise), DENACOL EX-721 as diglycidyl phthalate (manufactured by Nagase ChemteX Corporation, viscosity at 25° C.: 9.8 poise), Araldite CY177 as alicyclic epoxy resin (viscosity at 25° C.: 6.5 poise), and CY179 (viscosity at 25° C.: 3.5 poise) (all manufactured by Ciba Geigy A.G.), DENACOL EX-314 as triglycidyl ether of glycerin (viscosity at 25° C.: 1.7 poise), and DENACOL EX-411 as tetraglycidyl ether of pentaerythritol (viscosity at 25° C.: 8.0 poise) (all manufactured by Nagase ChemteX Corporation), TETRAD-X as tetraglycidyl m-xylylene diamine (manufactured by MITSUBISHI GAS CHEMICAL COMPANY, INC., viscosity at 25° C.: 20 poise or more and 35 poise or less), SUMI-EPOXY ELM100 as triglycidyl-m-aminophenol (manufactured by Sumitomo Chemical Co., Ltd., viscosity at 25° C.: 10 poise or more and 17 poise or less), Araldite 0500 (manufactured by Ciba Geigy A.G., viscosity at 25° C.: 5.5 poise or more and 8.5 poise or less), GAN as diglycidyl aniline (viscosity at 25° C.: 1.0 poise or more and 1.6 poise or less), and diglycidyl amine of o-toluidine (viscosity at 25° C.: 0.3 poise or more and 0.8 poise or less) (all manufactured by Nippon Kayaku Co., Ltd.), a biphenyl type epoxy resin, diclyclo pentadiene type epoxy resin, a phenol novoloc type epoxy resin, a cresol novoloc type epoxy resin, a tetraglycidyl diamine type epoxy resin, and a glycidyl phenyl ether type epoxy resin. Furthermore, an epoxy resin resulting from modification of those epoxy resins or a brominated epoxy resin resulting from bromination of those epoxy resins can be also mentioned.

As for the epoxy resin composition used as the component (C), at least one epoxy resin which is in liquid state at 25° C. can be suitably selected as described above. However, from the viewpoint of having excellent het resistance of a cured product, it is preferably a bi- or higher functional epoxy resin, and in particular, a bifunctional epoxy resin of bisphenol type is more preferable in that it has a tendency of having excellent inhibition on void during molding so as not to have any rapid increase in viscosity after arriving at curing temperature. Furthermore, it is particularly preferable that part or all of the component (C) is a bisphenol F type epoxy resin as a tendency of having excellent bending elastic modulus can be obtained.

It is preferable that the component (C) is preferably 20 parts by mass or more and 99 parts by mass or less, more preferably 25 parts by mass or more and 80 parts by mass or less, even more preferably 25 parts by mass or more and 50 parts by mass or less, and particularly preferably 25 parts by mass or more and 45 parts by mass or less relative to 100 parts by mass of the total amount of the whole epoxy resin contained in the epoxy resin composition. That is because, there is a tendency that, as the amount of the component (C) is 20 parts by mass or more, the viscosity the epoxy resin composition of the invention can be easily controlled within a suitable range, the viscous property of a prepreg containing the epoxy resin composition is regulated, and a molded article with fewer voids can be obtained when a fiber-reinforced plastic is produced. Furthermore, there is a tendency that, as the amount of the component (C) is 99 parts by mass or less, a suitable viscous property of a prepreg can be obtained, the handlability thereof tends to be improved, and the bending elastic modulus of the resin and the bending strain at break of the resin tend to increase.

“Component (D): Curing Agent”

The epoxy resin composition of the invention contains a curing agent as the component (D).

Type of the curing agent as the component (D) is not particularly limited, and examples thereof include amine-based curing agents, imidazoles, acid anhydrides, and boron chloride amine complexes. In particular, using dicyandiamide is preferable because properties of the epoxy resin composition before curing will not be affected by humidity in the air and it can be kept stable for a long period of time, and curing can be completed at a relatively low temperature. A preferred blending amount of the dicyandiamide is such that the molar number of active hydrogen of the dicyandiamide is 0.6 to 1.0 times the molar number of epoxy groups deriving from the all epoxy resins that are contained in the epoxy resin composition from the viewpoint of obtaining a cured product exhibiting good mechanical properties. It is further preferable to have 0.6 to 0.8 times, because even higher heat resistance can be obtained.

“Component (E): Urea-Based Curing Aid”

The epoxy resin composition of the invention may further contain a urea-based curing aid as the component (E).

In particular, when dicyandiamide is used as the component (D) and the component (E): urea-based curing aid is used in combination, the epoxy resin composition can be cured in a short period of time even at a low temperature, and therefore preferable.

Examples of the urea-based curing aid include urea derivative compounds such as 3-phenyl-1,1-dimethylurea (PDMU), toluene bisdimethyl urea (TBDMU), and 3-(3,4-dichlorophenyl)-1,1-dimethylurea (DCMU), but not limited thereto. The urea-based curing aid may be used either singly or in combination of two or more types. Among those, 3-phenyl-1,1-dimethylurea and toluene bisdimethyl urea are particularly preferable from the viewpoint of having higher heat resistance and bending strength of a cured product of the epoxy resin composition, and shorter curing time of the epoxy resin composition. Furthermore, use of 3-phenyl-1,1-dimethyl urea or 3-(3,4-dichlorophenyl)-1,1-dimethyl urea is preferable in that a cured product of the epoxy resin composition containing them can have particularly high toughness.

The blending amount of the component (E) is preferably 1 part by mass or more and 5 parts by mass or less relative to 100 parts by mass of the total amount of the epoxy resin contained in the epoxy resin composition from the viewpoint of obtaining a favorable cured product. It is particularly preferably 1.5 parts by mass or more and 4 parts by mass or less.

“Thermoplastic Resin”

In the epoxy resin composition of the invention, a thermoplastic resin may be further contained, if necessary. With the thermoplastic resin, there is a tendency that the resin bending strain at break of a cured product can be enhanced.

The thermoplastic resin can be suitably selected from a phenoxy resin, a polyvinyl acetal resin, a triblock copolymer of poly(methyl methacrylate)/poly(butyl acrylate)/poly(methyl methacrylate), and a triblock copolymer of poly(styrene)/poly(butadiene)/poly(methacrylic acid methyl). However, when a phenoxy resin is used, there is a tendency that the resin bending strain at break of a cured product described above and resin bending elastic modulus described above can be obtained simultaneously.

Examples of the phenoxy resin which is used for the epoxy resin composition of the invention include a bisphenol A type phenoxy resin, a bisphenol F type phenoxy resin, and a phenoxy resin in which bisphenol A type and bisphenol F type are mixedly present, but not limited thereto. Furthermore, it is also possible that the phenoxy resin is used in combination of two or more types.

The mass average molecular weight of the phenoxy resin is preferably 50000 or more and 80000 or less. That is, when the mass average molecular weight of the phenoxy resin is 50000 or more, having excessively low viscosity of the epoxy resin composition can be prevented, and there is a tendency that the viscosity of the epoxy resin composition can be adjusted to a suitable viscosity range with a suitable blending amount. On the other hand, when the mass average molecular weight is 80000 or less, dissolution into an epoxy resin can be achieved so that there is a tendency that having excessively high viscosity of the epoxy resin composition can be prevented even with an extremely small blending amount, and the viscosity of the epoxy resin composition can be adjusted to a suitable viscosity range.

Specific examples of the phenoxy resin include YP-50, YP-50S, and YP-70 (all trade names, and manufactured by NIPPON STEEL & SUMIKIN CHEMICAL CO., LTD.), and jER1256, jER4250, and jER4275 (all trade names, and manufactured by Mitsubishi Chemical Corporation).

Specific examples of the polyvinyl acetal resin include polyvinyl formal such as Vinylec K (average molecular weight: 59000), Vinylec L (average molecular weight: 66000), Vinylec H (average molecular weight: 73000), or Vinylec E (average molecular weight: 126000) (all trade names, and manufactured by CHISSO CORPORATION), polyvinyl acetal such as S-LEC K (manufactured by SEKISUI CHEMICAL CO., LTD.), and polyvinyl butyral such as S-LEC B (manufactured by SEKISUI CHEMICAL CO., LTD.) or Denka butyral (manufactured by Denka Company Limited).

Specific examples of the triblock copolymer include a triblock copolymer of poly(methyl methacrylate)/poly(butyl acrylate)/poly(methyl methacrylate) and a triblock copolymer of poly(styrene)/poly(butadiene)/poly(methacrylic acid methyl). Namely, there is a triblock copolymer in which poly(methyl methacrylate), poly(butyl acrylate), and poly(methyl methacrylate) are copolymerized in the order and a triblock copolymer in which poly(styrene), poly(butadiene), and poly(methacrylic acid methyl) are copolymerized in the order.

By selecting as a center soft block a polymer which is incompatible with an epoxy resin and as one or both ends of a hard block a polymer which is easily compatible with an epoxy resin, the triblock copolymer can be micro-dispersed in the epoxy resin. The polymer constituting a soft block has lower glass transition temperature than the polymer constituting a hard polymer, and thus it has more favorable fracture toughness. As such, according to micro-dispersion of the triblock copolymer with such structure in an epoxy resin, it becomes possible that a decrease in heat resistance of a cured product of the epoxy resin composition can be suppressed and also the fracture toughness of a cured product of the epoxy resin composition can be enhanced.

A triblock copolymer of poly(methyl methacrylate)/poly(butyl acrylate)/poly(methyl methacrylate) having at both ends thereof a hard block as a polymer easily compatible with an epoxy resin exhibits favorable dispersion in the epoxy resin so that the fracture toughness of a cured product of the epoxy resin composition can be greatly enhanced, and thus desirable. Examples of a commercially available triblock copolymer of poly(methyl methacrylate)/poly(butyl acrylate)/poly(methyl methacrylate) include Nanostrength (registered trademark) M52, M52N, M22, and M22N (all trade names, and manufactured by ARKEMA K.K.).

Furthermore, examples of a commercially available triblock copolymer of poly(styrene)/poly(butadiene)/poly(methacrylic acid methyl) include Nanostrength 123, 250, 012, E20, and E40 (all trade names) by Arkema.

The amount of the thermoplastic resin used in the epoxy resin composition of the invention is preferably in a range of 0.1 part by mass or more to 10 parts by mass or less, and more preferably 1 part by mass or more and 6 parts by mass or less relative to 100 parts by mass of the total amount of all epoxy resins contained in the epoxy resin composition. That is because, as the use amount of the thermoplastic resin is 0.1 part by mass or more, the resin bending strain at break of a cured product of the epoxy resin composition tends to increase. Furthermore, as the use amount of the thermoplastic resin is 10 parts by mass or less, the bending elastic modulus of a cured product of the epoxy resin composition tends to increase.

“Other Epoxy Resin”

The epoxy resin composition of the invention may also contain, within a range that the effect of the invention is not negatively affected, an epoxy resin other than the epoxy resin illustrated above as any one of the component (A), the component (B), and the component (C) (hereinbelow, referred to as the “other epoxy resin”).

Examples of the other epoxy resin include, as a bifunctional epoxy resin, bisphenol A type epoxy resins, bisphenol F type epoxy resins, glycidyl amine type epoxy resins, biphenyl type epoxy resins, dicyclopentadiene type epoxy resins, and epoxy resins obtained by modifying them. Examples of a polyfunctional epoxy resin with functionality of tri- or higher include phenol novolac epoxy resins, cresol novolac epoxy resins, tetraglycidyl di amine type epoxy resins such as tetraglycidyl diaminodiphenylmethane, and glycidyl phenyl ether type epoxy resins such as triaglycidyl aminophenol, tetrakis(glycidyloxyphenyl)ethane or tris (glycidyloxyphenyl)methane. In addition, epoxy resins obtained by modifying those epoxy resins, brominated epoxy resins obtained by brominating those epoxy resins and so on are also included, but not limited thereto. Furthermore, the epoxy resin may be used in combination of two or more types and used as other epoxy resin.

The amount of the “other epoxy resin” to be contained in the epoxy resin composition of the invention is preferably 30 parts by mass or less relative to 100 parts by mass of the total amount of all epoxy resins contained in the epoxy resin composition.

“Other Additives”

The epoxy resin composition of the invention may contain, within a range that the effect of the invention is not negatively affected, at least one additive selected from a group consisting of a thermoplastic resin other than the thermoplastic resin described above, a thermoplastic elastomer, and an elastomer. The additives not only play a role of optimizing viscosity, storage elasticity and thixotropic properties of the epoxy resin composition of the invention by modifying their visco-elasticity but also work to improve the toughness of a cured product of the epoxy resin composition of the invention. The thermoplastic resin, thermoplastic elastomer, and elastomer to be used as an additive may be used either singly or in combination of two or more types. Such an additive may be dissolved and blended in epoxy resin components, or may be contained in the epoxy resin composition in a state of fine particles, long fiber, short fiber, fabric, nonwoven cloth, mesh, pulp or the like. When the additive is provided on the surface layer of a prepreg in a state of fine particles, long fiber, short fiber, fabric, nonwoven cloth, mesh, pulp or the like, interlayer delamination of fiber-reinforced plastics is suppressed, and therefore preferable.

As for thermoplastic resin, it is preferred to select a thermoplastic resin that contains in its main chain a bonding selected from a group of carbon-carbon bonding, amide bonding, imide bonding, ester bonding, ether bonding, carbonate bonding, urethane bonding, urea bonding, thioether bonding, sulfonic bonding, imidazole bonding, and carbonyl bonding. More preferred examples are a group of thermoplastic resins which belong to engineering plastics such as polyacrylate, polyamide, polyaramid, polyester, polycarbonate, polyphenylene sulfide, polybenzimidazole, polyimide, polyether imide, polysulfone, or polyether sulfone. From the viewpoint of having excellent heat resistance, polyimide, polyether imide, polysulfone, and polyether sulfone or the like are particularly preferably used. Furthermore, having a functional group capable of reacting with epoxy resin in the thermoplastic resin is preferable from the viewpoint of increasing the toughness and maintaining environmental resistance of a cured product of the resin composition of the invention. Examples of the functional group preferred for a reaction with an epoxy resin include a carboxyl group, an amino group, and a hydroxyl group.

A cured product of the epoxy resin composition of the present satisfies the following (1) to (4).

[Physical Properties]

(1) Bending elastic modulus of a cured product of the epoxy resin composition is 3.3 GPa or higher,

(2) Bending strain at break of a cured product of the epoxy resin composition is 9% or higher,

(3) 90° Bending strength of a fiber-reinforced plastic composed of a cured product of the epoxy resin composition and a reinforcing fiber substrate, in which carbon fibers as continuous fibers are arranged evenly in one direction, is 150 MPa or higher, and

(4) 90° Bending strain at break of the fiber-reinforced plastic described in above (3) is 1.8% or higher.

In a cured product of the epoxy resin composition, enhancement of the bending elastic modulus and enhancement of bending strain at break are in a trade-off relationship. However, as a result of intensive studies, the inventors found that both of them can be obtained simultaneously at high level by controlling those physical properties within a specific range. By using such an epoxy resin composition, the fiber-reinforced plastic to be obtained can have improved fracture strength.

It was also found that, controlling the 90° bending strength of a fiber-reinforced plastic, which is measured at the conditions that are described below, within a specific range, is more effective for enhancement of the fracture strength of a fiber-reinforced plastic to be obtained.

It was also found that, although it has been remained difficult to obtain simultaneously the 90° bending strength and bending strain at break of a fiber-reinforced plastic, both physical properties can be obtained simultaneously at high level by using the epoxy resin composition of the invention. It was found that, by using such an epoxy resin composition, the fracture strength of a fiber-reinforced plastic to be obtained can be significantly improved.

By having the physical properties that are described above, the epoxy resin composition of the invention is particularly suitable for application to a tubular body of fiber-reinforced plastics.

Detailed descriptions are given hereinbelow

(1) Bending Elastic Modulus of Resin is 3.3 GPa or Higher

The bending elastic modulus of the resin in the invention is a value measured by the following method.

A 2 mm-thick cured resin sheet obtained by curing the epoxy resin composition is processed into a test piece (60 mm long×8 mm wide). Then, elastic modulus of the test piece is measured by using INSTRON 4465 tester equipped with a 500 N load cell and using a three-point bending jig (load applicator R=3.2 mm, support R=3.2 mm) under conditions of temperature at 23° C. and humidity of 50% RH. At that time, distance (L) between supports and thickness (d) of the test piece are set at a ratio (L/d) of 16 and the test piece is bent to measure elastic modulus.

When the epoxy resin composition of which resin bending elastic modulus is 3.3 GPa or higher is used as a matrix resin composition of a fiber-reinforced plastic, high 0° bending strength is obtained. In addition, when the fiber-reinforced plastic has a tubular shape, the tubular body has high bending strength.

It is sufficient that the resin bending elastic modulus is 3.3 GPa or higher. However, if it is 3.4 GPa or higher, a fiber-reinforced plastic with even higher 0° bending strength and 90° bending strength can be obtained, and therefore preferable. The upper limit of the resin bending elastic modulus is, although not particularly limited, 6.0 GPa or lower in general.

(2) Bending Strain at Break of Resin is 9% or Higher

The bending strain at break of the resin is a value measured by the following method.

A 2 mm-thick cured resin sheet obtained by curing the epoxy resin composition is processed into a test piece (60 mm long×8 mm wide). Then, the measurement was made by using INSTRON 4465 tester equipped with a 500 N load cell and using a three-point bending jig (load applicator R=3.2 mm, support R=3.2 mm) under conditions of temperature at 23° C. and humidity of 50% RH. At that time, distance (L) between supports and thickness (d) of the test piece are set at a ratio (L/d) of 16 and the test piece is bent to obtain strain under maximum load and strain at break. If the test piece is not broken even after resin bending test, the device is stopped when the strain is more than 13%, and the value at that time is taken as strain at break.

When an epoxy resin composition of which the resin bending strain at break is 9% or higher is used as a matrix resin of a fiber-reinforced plastic, high 90° bending strength is obtained. Furthermore, when the fiber-reinforced plastic has a tubular shape, the tubular body has high bending strength.

It is sufficient that the resin bending strain at break is 9% or higher. However, when it is 11% or higher, even higher 90° bending strength can be obtained, and thus more preferable. It is even more preferably 12% or higher. The upper limit of the resin bending strain at break is 13% as it is clearly shown by the measurement method described above.

(3) 90° Bending Strength of Fiber-Reinforced Plastic is 150 MPa or Higher

The 90° bending strength of a fiber-reinforced plastic is a value measured by the following method.

First, carbon fibers are evenly aligned in one direction, and a prepreg which has fiber weight per unit area of 125 g/m²and the resin content of 28% by mass is produced. Then, it is cured to produce a fiber-reinforced plastic panel.

The obtained fiber-reinforced plastic is processed into a test piece (60 mm long×12.7 mm wide) in such a way that reinforcing fibers have an orientation angle of 90° to a length side of the test piece. Then, the measurement is made by using a universal testing instrument manufactured by Instron Japan Company Limited and using a three-point bending jig (load applicator R=5 mm, support R=3.2 mm) under conditions of temperature at 23° C. and humidity of 50% RH. Meanwhile, at conditions in which the ratio of distance (L) between supports to thickness (d) of the test piece is as follows: L/d=16, and a crosshead speed is as follows: (rate per minute)=(L2×0.01)/(6×d), the test piece is then bent and bending strength and strain at break are measured.

When the fiber-reinforced plastic has 90° bending strength of 150 MPa or higher, a fiber-reinforced plastic tubular body with high bending strength is obtained with regard to a tubular body of fiber-reinforced plastics. It is sufficient that the fiber-reinforced plastic has 90° bending strength of 150 MPa or higher. However, if it is 160 MPa or higher, a tubular body with even higher bending strength is obtained, and thus more preferable.

(4) 90° Bending Strain at Break of Fiber-Reinforced Plastic is 1.8% or Higher

Furthermore, when 90° bending strain at break of a fiber-reinforced plastic is 1.8% or higher, a tubular body with high bending strength is obtained. The 90° bending strain at break is more preferably is 1.9% or higher.

By coating the epoxy resin composition of the invention on release paper or the like, a film of resin can be obtained. As an intermediate material for producing a prepreg, the film of the invention can be laminated on a substrate and cured, and then it can be advantageously used for a surface protecting film or an adhesive film.

Furthermore, a prepreg can be obtained by impregnating the epoxy resin composition of the invention in a reinforcing fiber substrate. The reinforcing fiber substrate which may be used for the prepreg of the invention is not limited, and examples thereof include those in which carbon fibers, graphite fibers, glass fibers, organic fibers, boron fibers, steel fibers, and the like are in a state of tow, cloth, or chopped fiber, continuous fibers evenly aligned to have a unidirectional orientation, continuous fibers woven to have vertical and horizontal orientations, tows in a unidirectional alignment and held by a horizontal auxiliary yarn, multiple unidirectional reinforcing fiber sheets laminated in different directions and stitched with an auxiliary yarn so as to form multiaxial warp knit, non-woven reinforcing fibers, and the like.

As reinforcing fibers constituting those reinforcing fiber substrates, carbon fibers and graphite fibers can be preferably used in the prepreg of the invention since they have an excellent specific elastic modulus and contribute significantly to have light weight. Also, any kind of carbon fibers and graphite fibers can be used for depending on use.

A fiber-reinforced plastic containing a cured product of the epoxy resin composition and reinforcing fibers can be obtained by applying and curing the prepreg of the invention. Use of a fiber-reinforced plastic is not particularly limited, and for example, they can be used in general industrial applications such as aircraft structural material, automobiles, ships, sports equipment, windmills, rolls and the like. As for the method for producing a fiber-reinforced plastic, examples thereof include a molding method in which, after processing into a sheet-like molding intermediate referred to as a prepreg, autoclave molding, sheet wrap molding, press molding or the like is carried out, and RTM, VaRTM, filament winding, RFI or the like in which an epoxy resin composition is impregnated in a filament or a perform of reinforcing fibers followed by curing to obtain a molded product, but the method is not limited to those molding methods.

Furthermore, by preparing the fiber-reinforced plastic of the invention in tubular body form, it can be particularly suitably used for golf club shaft having very high fracture strength or the like.

### EXAMPLES

Hereinbelow, the invention is described specifically in view of the examples. However, it is evident that the invention is not limited by those examples at all.

<Raw Materials>

Component (A):

NER-7604 (trade name): polyfunctional bisphenol F type epoxy resin, epoxy equivalents of 350 g/eq, softening point of 70° C., manufactured by Nippon Kayaku Co., Ltd.

NER-7403 (trade name): polyfunctional bisphenol F type epoxy resin, epoxy equivalents of 300 g/eq, softening point of 58° C., manufactured by Nippon Kayaku Co., Ltd.

NER-1302 (trade name): polyfunctional bisphenol A type epoxy resin, epoxy equivalents of 330 g/eq, softening point of 70° C., manufactured by Nippon Kayaku Co., Ltd.

Component (B):

AER4152 (trade name “Araldite AER4152”): bifunctional epoxy resin having oxazolidone ring in the skeleton, number average molecular weight of 814, manufactured by ASAHI KASEI E-materials Corp.

jER1001 (trade name): bisphenol A type bifunctional epoxy resin, epoxy equivalents of 450 g/eq or more and 500 g/eq or less, number average molecular weight of 900, manufactured by Mitsubishi Chemical Corporation

EHPE3150 (trade name): solid alicyclic epoxy resin, softening point: 75° C., manufactured by Daicel Corporation

EXA-1514 (trade name): bisphenol S type epoxy resin, softening point: 75° C., manufactured by DIC CORPORATION

EXA-1517 (trade name): bisphenol S type epoxy resin, softening point: 60° C., manufactured by DIC CORPORATION

jER4004P (trade name): bisphenol F type bifunctional epoxy resin, epoxy equivalents of 840 g/eq or more and 975 g/eq or less, softening point: 85° C., manufactured by Mitsubishi Chemical Corporation

Component (C):

jER828 (trade name): bisphenol A type bifunctional epoxy resin, epoxy equivalents of 189 g/eq, manufactured by Mitsubishi Chemical Corporation

jER807 (trade name): bisphenol F type bifunctional epoxy resin, epoxy equivalents of 167 g/eq, manufactured by Mitsubishi Chemical Corporation

Thermoplastic Resin:

YP-50S (trade name): phenoxy resin, mass average molecular weight of 50000 or more and 70000 or less, manufactured by NIPPON STEEL & SUMIKIN CHEMICAL CO., LTD.

M52N (trade name “Nanostrength M52N”), triblock copolymer of acrylic block copolymer (poly(methyl methacrylate)/poly(butyl acrylate)/poly(methyl methacrylate), and also copolymerized with dimethyl acrylamide, manufactured by ARKEMA K.K.

Component (D):

DICY15 (trade name): dicyandiamide, manufactured by Mitsubishi Chemical Corporation

Component (E):

DCMU99 (trade name): 3-(3,4-dichlorophenyl)-1,1-dimethyl urea, manufactured by Hodogaya Chemical Co., Ltd.

Omicure94 (trade name): 3-phenyl-1,1-dimethyl urea, manufactured by PTI JAPAN Corporation

### Examples 1 to 7, Comparative Examples 1 and 2

An epoxy resin composition was prepared in the following order, and the resin bending elastic modulus, resin bending strain at break, and bending strength of a fiber-reinforced plastic were measured. The resin composition and results of the measurement (evaluation) are shown in Table 1.

<Preparation of Catalyst Resin Composition>

By using a three-roll mill, the component (D) and the component (E) shown in Table 1 were homogeneously dispersed in part of the liquid epoxy resin component which is included in the resin composition shown in Table 1 to prepare the catalyst resin composition.

<Preparation of Epoxy Resin Composition>

Part of the solid epoxy resin component included in the resin composition shown in Table 1, part of the remaining liquid epoxy resin component, and a thermoplastic resin were heated and mixed at 160° C. to obtain a homogeneous master batch (1).

The obtained master batch (1) was cooled to 120° C. Thereafter, the remaining solid epoxy resin component was added thereto. According to mixing at 120° C. followed by homogeneous dispersing, a master batch (2) was obtained.

The obtained master batch (2) was cooled to 60° C., and then added with the catalyst resin composition, which has been prepared in advance, and the remaining liquid epoxy resin component after weighting. According to mixing at 60° C. followed by homogeneous dispersing, an epoxy resin composition was obtained.

<Production of Cured Resin Plate>

The epoxy resin composition prepared according to above <Preparation of epoxy resin composition> was sandwiched between glass plates with a 2 mm thick spacer made of polytetrafluoroethylene. Then, the temperature was raised at temperature increase rate of 2° C./min, and the composition was cured by maintaining the temperature at 130° C. for 90 minutes. Accordingly, a cured resin plate was obtained.

<Measurement of Resin Bending Elastic Modulus and Resin Bending Strain at Break>

The 2 mm thick cured resin plate produced in the aforementioned <Production of cured resin plate> was processed into a test piece (60 mm long×8 mm wide). Then, measurement was carried out by using INSTRON 4465 tester equipped with a 500 N load cell and using a three-point bending jig (load applicator R=3.2 mm, support R=3.2 mm) under conditions of temperature at 23° C. and humidity of 50% RH. At that time, distance (L) between supports and thickness (d) of the test piece are set at a ratio (L/d) of 16 and the test piece was bent to measure elastic modulus, strain under maximum load, and strain at break. The results are shown in Table 1.

Meanwhile, if the test piece is not broken by the resin bending test, the device is stopped when the strain is more than 13%, and the value at that moment is taken as strain at break.

<Method for Producing Composite (Fiber-Reinforced Plastic) Panel>

The epoxy resin composition prepared in the aforementioned <Preparation of epoxy resin composition> was heated to 60° C., and according to application on a release paper using film coater, a resin film was produced. The thickness of the resin film was set such that, when a prepreg is produced by using two pieces of the resin film as described below, the resin content in the prepreg is 28% by mass.

On top of the resin film (resin film-formed side surface of a release paper), carbon fibers (TR50S, made by Mitsubishi Rayon Co., Ltd.) were wound using a drum winding device to form a sheet with a weight per unit fiber area of 125 g/m². In addition, another resin film was laminated on the carbon fiber sheet using the drum winding device. The carbon-fiber sheet sandwiched between two resin films was passed through a fusing press under conditions of temperature at 100° C., pressure at 0.4 MPa, and a feed rate at 3 m/min (JR-600S, made by Asahi Corporation, processing length of 1340 mm, cylinder pressure). Accordingly, a prepreg with weight per unit fiber area of 125 g/m² and a resin content of 28% by mass was obtained.

Then, 18 sheets of the obtained prepreg were laminated and placed in an autoclave under conditions of pressure at 0.04 MPa to increase the temperature at 2° C./min. After keeping it for 60 minutes at 80° C., the temperature was further increased at 2° C./min to 130° C. Then, according to heating and curing for 90 minutes at a pressure of 0.6 MPa, a fiber-reinforced plastic panel was obtained.

<Measurement of Composite (Fiber-Reinforced Plastic) Bending Strength>

The fiber-reinforced plastic panel obtained in the above <Method for producing composite (fiber-reinforced plastic) panel> was processed into a test piece to the size described below in such a way that reinforcing fibers have an orientation angle of 0° or 90° to a length direction of the test piece. Then, bending strength at 0° and 90°, elastic modulus, and strain at break were measured by using a universal testing instrument (manufactured by Instron Japan Company Limited) and using a three-point bending jig (load applicator R=5 mm, support R=3.2 mm) under conditions of temperature at 23° C. and humidity of 50% RH. At that time, distance (L) between supports and thickness (d) of the test piece are set to have the conditions of the L/d as described below, and the conditions of a crosshead speed are as follows: (rate per minute)=(L2×0.01)/(6×d). The 0° bending property was converted to have Vf60%. The results are shown in Table 1.

For evaluation of 0° bending property: length 100 mm×width 12.7 mm, L/d=40

For evaluation of 90° bending property: length 60 mm×width 12.7 mm, L/d=16

TABLE 1

| | | | | Exam- | Exam- | Exam- | Exam- | Exam- | Exam- | Exam- | Comparative | Comparative |
|---|---|---|---|---|---|---|---|---|---|---|---|---|
| | | | Unit | ple 1 | ple 2 | ple 3 | ple 4 | ple 5 | ple 6 | ple 7 | Example 1 | Example 2 |
| Component (A) | NER-7604 | | Parts by | 52 | 19 | 9 | 52 | 9 | 52 | 60 | | |
| | NER-7403 | | mass | | | | | | | | | |
| | NER-1302 | | | | | | | | | | | |
| Component (B) | AER4152 | | | | 25 | 44 | | 35 | | | | |
| | jER1001 | | | | | | | | | | 46 | 66 |
| | EHPE3150 | | | 9 | 7 | 9 | 9 | | 9 | | 9 | 9 |
| | EXA-1514 | | | | 10 | | | | | | | |
| | EXA-1517 | | | | | | | 18 | | | | |
| | jER4004P | | | | | | | | | | 7 | |
| Component (C) | jER807 | | | 39 | | 39 | 39 | | | | | 38 |
| | jER828 | | | | 39 | | | 39 | 39 | 40 | 38 | |
| Component (D) | Dicy15 | | | 6 | 6 | 6 | 6 | 6 | 6 | 6 | 6 | 5 |
| Component (E) | DCMU99 | | | 4 | 4 | 4 | 4 | 4 | | 4 | 4 | 3 |
| | Omicure94 | | | | | | | | 4 | | | |
| Thermoplastic | YP-50S | | | 5 | 5 | 5 | 4 | | 5 | 5 | 5 | 5 |
| resin | M52N | | | | | | 1 | | | | | |
| Bending | Elastic | | GPa | 3.5 | 3.4 | 3.5 | 3.5 | 3.4 | 3.4 | 3.4 | 3.4 | 3.4 |
| physical | modulus | | | | | | | | | | | |
| properties of | Strain under maximum | | % | 6.9 | 7.2 | 7.2 | 6.9 | 7.3 | 7.1 | 7.1 | 5.5 | 7.2 |
| cured resin | load | | | | | | | | | | | |
| | Strain at break | | % | 11.2 | 12.6 | 12.5 | 10.8 | 11.5 | 11.9 | 12.5 | 6.2 | 10.0 |
| Composite | 0° | Strength | MPa | 1839 | 1769 | 1723 | 1797 | 1825 | 1740 | 1738 | 1570 | 1838 |
| physical | Bending | Elastic | GPa | 127 | 124 | 131 | 130 | 129 | 129 | 130 | 128 | 124 |
| properties | | modulus | | | | | | | | | | |
| | | Strain at | % | 1.7 | 1.5 | 1.4 | 1.3 | 1.6 | 1.7 | 1.6 | 1.3 | 1.5 |
| | | break | | | | | | | | | | |
| | 90° | Bending | MPa | 158 | 165 | 153 | 153 | 162 | 153 | 154 | 135 | 127 |
| | Bending | strength | | | | | | | | | | |
| | | Elastic | GPa | 8.8 | 9.0 | 8.0 | 8.6 | 8.5 | 8.7 | 8.6 | 8.9 | 7.4 |
| | | modulus | | | | | | | | | | |
| | | Bending | % | 1.9 | 2.0 | 1.8 | 1.8 | 1.9 | 1.8 | 1.8 | 1.6 | 1.4 |
| | | strain | | | | | | | | | | |
| | | at break | | | | | | | | | | |

In any of Examples 1 to 7, the resin bending elastic modulus was higher than 3.3 GPa, the resin strain at break was 9% or higher, the 90° bending strength of a fiber-reinforced plastic was 150 MPa or higher, and the 90° bending strain at break of a fiber-reinforced plastic was 1.8% or higher. Meanwhile, in Comparative Example 1, the strain at break was lower than 9%, and the 90° bending strength of a fiber-reinforced plastic of Comparative Example 1 was lower than 150 MPa. In Comparative Example 2, the 90° bending strength of a fiber-reinforced plastic was lower than 150 MPa.

### Examples 8 to 10, Comparative Example 3

An epoxy resin composition was prepared in the above order, and, by using it, the resin bending elastic modulus and resin bending strain at break were measured by the aforementioned method. The resin composition and results of the measurement (evaluation) are shown in Table 2.

| | | | Exam- | Exam- | Exam- | Comparative |
|---|---|---|---|---|---|---|
| | | Unit | ple 8 | ple 9 | ple 10 | Example 3 |
| Component (A) | NER-7604 | Parts by | 26 | 9 | | |
| | NER-7403 | mass | | 35 | | 66 |
| | NER-1302 | | | | 44 | |
| Component (B) | AER4152 | | | | | |
| | jER1001 | | 26 | | | 26 |
| | EHPE3150 | | 9 | | | 9 |
| | EXA-1514 | | | 18 | | |
| | EXA-1517 | | | | 18 | |
| | jER4004P | | | | | |
| | N-775 | | | | | |
| Component (C) | jER807 | | 39 | 38 | 39 | |
| | jER828 | | | | | |
| Component (D) | Dicy15 | | 6 | 6 | 6 | 5 |
| Component (E) | DCMU99 | | 4 | 4 | 4 | 3 |
| | Omicure94 | | | | | |
| Thermoplastic | YP-50S | | 5 | 5 | 5 | 5 |
| resin | M52N | | | | | |
| Bending | Elastic | GPa | 3.5 | 3.4 | 3.4 | 3.3 |
| physical | modulus | | | | | |
| properties of | Strain under | % | 6.8 | 6.9 | 7.1 | 5.3 |
| cured resin | maximum load | | | | | |
| | Strain | % | 11.0 | 11.8 | 11.2 | 5.3 |
| | at break | | | | | |

In any of Examples 8 to 10, the resin bending elastic modulus was higher than 3.3 GPa and the resin strain at break was 9% or higher. Meanwhile, in Comparative Example 3, the strain at break was found to be low.

### INDUSTRIAL APPLICABILITY

With use of the epoxy resin composition of the invention, an excellent fiber-reinforced plastic tubular body can be obtained. As such, the invention can provide a wide range of fiber-reinforced plastic molded products with excellent mechanical properties, for example, from a molded product for sports and leisure applications such as golf club shaft to a molded product for industrial applications such as aircrafts.

1. An epoxy resin composition, comprising:
component (A): an epoxy resin represented by Chemical Formula (1);
component (C): an epoxy resin other than the component (A) which is in liquid phase at 25° C.; and
component (D): a curing agent: 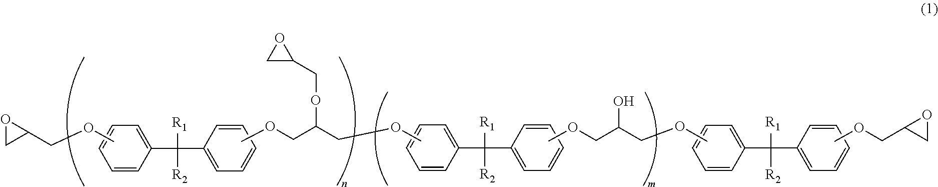
where, n and m represent a mean value, n is a real number within a range of from 1 to 10, m is a real number within a range of from 0 to 10, and R₁ and R₂ each independently represent a hydrogen atom or any one of an alkyl group comprising 1 to 4 carbon atoms and a trifluoromethyl group.

2. The epoxy resin composition according to claim 1, further comprising:
component (B): an epoxy resin other than the component (A) which is solid at 25° C.

3. The epoxy resin composition according to claim 1, wherein a content of the component (A) is 1 part by mass or more and 80 parts by mass or less relative to 100 parts by mass of a total amount of the epoxy resin contained in the epoxy resin composition.

4. The epoxy resin composition according to claim 2, wherein the component (B) is a solid epoxy resin having softening point or melting point of 50° C. or higher.

5. The epoxy resin composition according to claim 2, wherein the component (B) is at least one epoxy resin selected from the group consisting of bisphenol A type epoxy resin, bisphenol F type epoxy resin, bisphenol S type epoxy resin, oxazolidone ring type epoxy resin, and alicyclic epoxy resin.

6. The epoxy resin composition according to claim 2, wherein the component (B) is alicyclic epoxy resin represented by Chemical Formula (2): 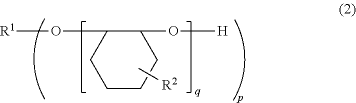
where, R¹ represents an organic group with valency of p; p represents an integer of 1 to 20; q represents an integer of 1 to 50, and a total of q in Formula (2) is an integer of 3 to 100; R² represents any one group represented by Formula (2a) or (2b), with the proviso that at least one R² in Formula (2) is a group represented by Formula (2a):

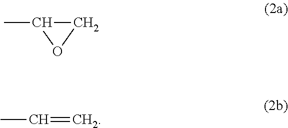

7. The epoxy resin composition according to claim 6, wherein the alicyclic epoxy resin is 1,2-epoxy-4-(2-oxyranyl)cyclohexane adduct of 2,2-bis(hydroxymethyl)-1-butanol.

8. The epoxy resin composition according to claim 2, wherein a content of the component (B) is 5 parts by mass or more and 60 parts by mass or less relative to 100 parts by mass of a total amount of the epoxy resin contained in the epoxy resin composition.

9. The epoxy resin composition according to claim 1, wherein the component (C) is a bi- or higher functional epoxy resin.

10. The epoxy resin composition according to claim 9, wherein the component (C) is a bisphenol type epoxy resin.

11. The epoxy resin composition according to claim 1, wherein a content of the component (C) is 20 parts by mass or more and 99 parts by mass or less relative to 100 parts by mass of a total amount of the epoxy resin contained in the epoxy resin composition.

12. The epoxy resin composition according to claim 1, wherein the component (D) is dicyandiamide.

13. The epoxy resin composition according to claim 1, further comprising a urea-based curing aid as component (E).

14. The epoxy resin composition according to claim 1, further comprising a thermoplastic resin is contained at 0.1 to 10 parts by mass relative to 100 parts by mass of a total amount of the epoxy resin contained in the epoxy resin composition.

15. The epoxy resin composition according to claim 14, wherein the thermoplastic resin is at least one selected from the group consisting of a phenoxy resin, a polyvinyl acetal resin, a triblock copolymer of poly(methyl methacrylate)/poly(butyl acrylate)/poly(methyl methacrylate), and a triblock copolymer of poly(styrene)/poly(butadiene)/poly(methacrylic acid methyl).

16. A film, comprising the epoxy resin composition according to claim 1.

17. A prepreg, having the epoxy resin composition according to claim 1 impregnated in a reinforcing fiber substrate.

18. A fiber-reinforced plastic, comprising
a cured product of the epoxy resin composition according to claim 1 and
a reinforcing fiber.

19. The fiber-reinforced plastic according to claim 18, wherein the plastic has a tubular shape.

20. An epoxy resin composition, comprising an epoxy resin and a curing agent, and satisfies the following (1) to (4):
(1) bending elastic modulus of a cured product of the epoxy resin composition is 3.3 GPa or higher;
(2) bending strain at break of the cured product of the epoxy resin composition is 9% or higher;
(3) 90° bending strength of a fiber-reinforced plastic comprising the cured product of the epoxy resin composition and a reinforcing fiber substrate, in which carbon fibers as continuous fibers are arranged evenly in one direction, is 150 MPa or higher; and
(4) 90° bending strain at break of the fiber-reinforced plastic is 1.8% or higher.
